(19) United States
(12) Patent Application Publication
(10) Pub. No.: US 2007/0012412 A1
(43) Pub. Date: Jan. 18, 2007

(54) Laminate paper having increased pH stability and method of making same

(75) Inventors: John H. Goodrow, Kennesaw, GA (US); Peter J. Nero, Marietta, GA (US)

Correspondence Address: DORITY & MANNING, P.A., POST OFFICE BOX 1449, GREENVILLE, SC, 29602-1449, US

(73) Assignee: Schweitzer-Mauduit International, Inc.

(21) Appl. No.: 11/182,522

(22) Filed: Jul. 15, 2005

(51) Int. Cl. D21H 27/30; D21H 27/26; D21H 21/28; B32B 29/00; D21H 21/10; D21H 17/09; D21H 21/18

(52) U.S. Cl. 162/123; 428/537.5; 162/162; 162/181.1; 162/164.1

(57) ABSTRACT

Laminate papers for use in decorative laminates and a process for producing the laminate paper is disclosed. The laminate paper is made using a sulfur dye. In the past, sulfur dyes caused acidification of the paper, causing the paper to become brittle. In accordance with the present invention, a buffering agent is added in relatively low amounts in order to inhibit acidification of the paper. It was discovered that the buffering agents also provided various other advantages and benefits.

### BACKGROUND OF THE INVENTION

Decorative laminate furniture has become a very popular consumer item. This type of furniture, which is much less expensive than conventional furniture, is made from panels of decorative laminates. Decorative laminates are multi-layered structures typically including a base material, an intermediate printed or colored overlay layer, and sometimes a scratch resistant clear topcoat. Besides being used to make furniture, other applications for decorative laminates include doors, molding strips, counter tops, flooring and various other items.

In the past, the decor layer as described above was made from a sheet of paper dyed to a particular color. For instance, one class of dyes that has been used in the past includes leuco sulfur dyes. The sulfur dyes, however, have a tendency to acidify the paper over time. Acidification causes the paper to become brittle and ultimately reduces the shelf life of the product. As such, a need currently exists for a method and process of reducing the acidification of the laminate paper when sulfur dyes are used.

### SUMMARY OF THE INVENTION

In general, the present disclosure is directed to a decor paper for use in laminates, such as furniture laminates. The present disclosure is also directed to a process for producing the decor paper and to a process for producing the corresponding laminates.

In one embodiment, for instance, the present disclosure is directed to a laminate paper comprising a paper substrate containing cellulosic fibers. The cellulosic fibers may include, for instance, softwood fibers, hardwood fibers, and mixtures thereof. If desired, the paper substrate may also include a filler, such as a non-reactive filler. The filler may be present in the paper substrate in an amount from about 4% to about 40% by weight and may comprise, for instance, a calcine clay, titanium dioxide, or mixtures thereof. Examples of clay materials that may be used a filler include washed clays, calcined clays, kaolin clays, and aluminosilicate clays.

In order to provide the paper substrate with a desirable color, the paper substrate further comprises a sulfur dye, such as a leuco sulfur dye. The sulfur dye, for instance, may have a red color, a blue color, a black color, and the like. In the past, such sulfur dyes have caused acidification of the paper substrate over time. In accordance with the present invention, however, a buffering agent is incorporated into the paper substrate that is added in amounts sufficient to inhibit acidification of the paper substrate. The buffering agent, for instance, may comprise an organic or inorganic mineral and may be present in the paper substrate in relatively low amounts, such as in an amount from about 0.2% to about 5% by weight, such as from about 0.5% to about 1.5% by weight.

The buffering agent may be incorporated into the paper substrate during formation of the paper, such as being added to the pulper furnish or by being added through an in-line slurry delivery system. Examples of buffering agents that may be used in accordance with the present invention include magnesium oxides, magnesium carbonate hydroxide, calcium silicate, calcium carbonate, aluminum oxides, aluminum hydroxide, an organic diatome such as diatomaceous earth, beryllium salts, barium salts, other Group II metal salts, and mixtures thereof.

In one embodiment, the buffering agent is incorporated into the paper substrate such that a hot water extract (as defined below) obtained from the paper substrate after the substrate is formed has a pH of greater than about 6.8, such as greater than 7.25. A hot water extract of the paper substrate after the paper substrate has been oven aged for a certain period of time may also remain relatively high. For instance, the pH of the paper substrate after being oven aged for two hours may be greater than about 6.8, such as greater than about 7.0, such as greater than about 7.2, and, in one embodiment, even greater than about 7.4. A hot water extract of the paper substrate after the paper substrate has been oven aged for 24 hours may have a pH of greater than about 6.8, such as greater than about 7.0, such as greater than about 7.2.

As used herein, oven aging is conducted in a forced air-drying oven at a temperature of 120° C. Hot water extracts of the paper substrate are obtained by combining one gram of the paper substrate with 50 cc of boiling water. The water and sample are mixed for five minutes and the pH of the hot water extract is measured after the solution has cooled to 50° C.

In addition to the above ingredients, the paper substrate may also contain a cationic retention aid. The cationic retention aid may be added for various purposes. For instance, the cationic retention aid may be used in order to control the pH of the paper substrate at the wet end of the process and/or to flocculate the fibers and fillers. The cationic retention aid may also be used to improve the strength of the paper substrate.

In general, any suitable cationic retention aid may be used in accordance with the present invention. Examples of cationic retention aids include polyaluminum silicate sulfate and aluminum sulfate. In still another embodiment, the cationic retention aid may comprise a cationic amine polymer-epichlorohydrine resin. In addition to the above, numerous polymeric cationic retention aids are also available that may be used in the present invention. In general, the cationic retention aid may be present in the paper substrate in an amount from about 2 lbs. per ton to about 20 lbs. per ton of furnish.

In general, the paper substrate may have a basis weight of from about 30 gsm to about 120 gsm, may have a tensile strength of from about 700 g/in to about 3500 g/in, and may have a BEKK smoothness of from about 10 seconds to about 600 seconds. The paper substrate may also have a Gurley porosity of from about 8 seconds per 100 cc of air to about 50 seconds per 100 cc of air, such as from about 10 seconds per 100 cc of air to about 20 seconds per 100 cc of air.

Once the paper substrate is formed, the paper substrate can be impregnated with a polymeric resin. The polymeric resin may be a thermoset resin or a thermoplastic resin. Examples of polymeric resins that may be used include melamine formaldehyde resins, polyester resins, and urea formaldehyde resins.

Once the paper substrate is impregnated with the polymeric resin or combinations of resins, the resin is partially cured. The impregnated paper is then bonded to a base material by completely curing the resin for use as a decorative laminate. If desired, a clear topcoat or cap sheet may be applied over the impregnated paper substrate to provide for scratch resistance.

Other features and aspects of the present invention are discussed in greater detail below.

### BRIEF DESCRIPTION OF THE DRAWINGS

FIG. 1 is a graphical representation of the results obtained in Example 2.

### DETAILED DESCRIPTION

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment may be used in another embodiment to yield a still further embodiment. Thus, it is intended that the present invention cover such modifications and variations as come within the scope of the appended claims and their equivalents.

In general, the present disclosure is directed to laminate papers incorporated into laminates that may be used, for instance, as furniture panels, countertops, flooring, molding, and the like. Decorative laminates are multi-layered structures containing a laminate paper that is adhered to a base material. The laminate paper, which is either a solid color or printed with a pattern or image, gives the decorative laminate its aesthetic appearance. In constructing decorative laminates, the laminate paper should be somewhat scratch resistant, wear resistant, and securely bonded to the base material.

Laminate papers made according to the present invention are dyed using, for instance, leuco sulfur dyes in a wet laid papermaking process. One problem that has been experienced in the past is that papers produced using leuco sulfur dyes have a limited shelf life due to the generation of acid in the sheet. Acidification of the paper substrate may cause the sheet to become brittle over time. When using sulfur dyes, for instance, the dyes typically require an oxidation stage and then an acidification stage in order to assist in attaching the dye to the pulp fibers and to allow for a desired deep color generation. During the acidification stage, the pH of the aqueous suspension that is used to form the paper substrate is adjusted to a level of between 6.5 and 7.0. Sodium carbonate may be added later in order to increase the pH as desired. Unfortunately, however, the sulfur dye may continue to generate acid after the sheet is formed, especially when contacted with any levels of moisture.

Various methods have been proposed in the past in order to neutralize acid groups in the sulfur dyes. For instance, U.S. Pat. No. 5,421,960 to Canary discloses a process in which relatively large amounts of an alkaline earth metal salt such as an alkaline earth metal sulfate or chloride may be added to the furnish in order to neutralize the acid groups contained in the dye. The alkaline earth metal salt is added to the furnish in an amount of from about 20-85% by weight and is then precipitated by adding sodium hydroxide.

In accordance with the present invention, however, relatively small amounts of a buffering agent are added during formation of a decor paper that inhibits the acidification of the paper. Of particular advantage, the buffering agent is added in amounts that do not affect any other properties of the paper and are added during formation of the paper without requiring any additional process steps. In accordance with the present invention, the buffering agent generally comprises an inorganic mineral, such as a magnesium salt that is added in amounts less than about 5% by weight, such as from 0.5% to about 5% by weight, and particularly from about 1% to about 2% by weight.

Inclusion of a buffering agent into a laminate paper in accordance with the present invention provides various benefits and advantages. As stated above, the buffering agent inhibits sulfur dyes present in the paper from acidifying the paper over time. By reducing the acidification rate, the shelf life of the laminate paper is greatly increased and the paper substrate is less likely to become brittle over time. Further, it has been discovered that the shelf life of the laminate paper is increased not only in its un-impregnated state, but also in its impregnated state with a polymeric resin. The extended shelf life allows producers to produce and hold greater inventories of the laminate paper in order to better meet customer demands.

In addition to increased shelf life, the present inventors have discovered that the buffering agent also provides various other benefits and advantages. For instance, presence of the buffering agent has also been found to provide greater control of the polymeric resin catalyst system that is used to catalyze the polymeric resin that is used to impregnate the paper. In particular, the catalyst system used to catalyze the polymeric resin may be sensitive to pH. Because the buffering agent of the present invention is capable of creating laminate papers having not only more stable pH levels but also more uniform pH levels, greater predictability is provided when adding the catalyst system to catalyze the polymeric resin.

In addition to the catalyst system for the polymeric resin, press cycle times during the process of laminating the impregnated laminate paper to a base material has also been found to be somewhat pH sensitive. By maintaining greater control over the pH of the laminate paper and by providing pH uniformity from batch to batch, press cycle times can be estimated with greater predictability. Specifically, by controlling the pH of the laminate paper, the cure rate during the lamination process is controlled and does not fluctuate.

As stated above, the buffering agent of the present invention generally comprises an inorganic mineral. In one particular embodiment, for instance, the buffering agent comprises a magnesium salt, such as a magnesium oxide or a magnesium carbonate hydroxide. In addition to magnesium salts, however, various other inorganic minerals may be used. For instance, a buffering agent may comprise calcium silicate (Wollastonite), aluminum oxides, aluminum hydroxide, diatomaceous earth, barium salts, beryllium salts, and mixtures of any of the above.

As described above, the buffering agent of the present invention is added in relatively low amounts. The buffering agent is added in an amount sufficient to inhibit acidification of the paper over time. Immediately after being formed, for instance, a hot water extract of a laminate paper made in accordance with the present invention may have a pH greater than about 6.8, such as greater than 7.0, such as greater than about 7.5, and even greater than about 7.7. After two hours of oven aging at 120° C., the pH of a hot water extract obtained from the laminate paper may also be greater than about 6.8, such as greater than about 7.0, such as greater than about 7.2, or, in one embodiment, greater than about 7.5. Similarly, after 24 hours of oven aging at 120° C. of the laminate paper, the pH of a hot water extract obtained from the paper may be greater than about 6.8, such as greater than about 7.0, and even greater than about 7.2. In certain embodiments, laminate papers over six days old at natural aging, may continue to have a pH as determined by a hot water extract of greater than about 7.25 or even greater than about 7.5.

A process by which laminate papers may be produced according to the present invention will now be described in greater detail.

Laminate papers are made from cellulosic fibers such as softwood fibers, hardwood fibers, or mixtures thereof. For example, in one embodiment, the fiber furnish used to make the paper can include from about 20% to about 100%, and more particularly from about 50% to about 80% by weight hardwood fibers mixed, if desired, with softwood fibers. Hardwood fibers particularly well suited for use in producing laminate papers include eucalyptus fibers. Softwood fibers may include, for instance, Northern softwood fibers. The fibers can be Kraft pulped fibers. Further, the fibers can be bleached or unbleached.

In order to lower the porosity of the laminate paper, the fiber furnish can be highly refined. Highly refined fibers also promote formation of the paper and produce a paper with a relatively smooth surface.

The cellulosic fibers are first combined with water to form an aqueous suspension of fibers. The aqueous suspension of fibers can be formed into a paper using, for instance, a Fourdrinier paper machine. The papermaking system, for instance, may include a series of wet pressing operations and steam dryer cans in order to form and dry the paper.

In addition to cellulosic fibers, in one embodiment, the aqueous suspension used to form the paper can contain various other ingredients and additives. For instance, a filler, such as a non-reactive filler may be added to the fiber furnish. The filler may be present in an amount from about 2% to about 40% by weight, such as from about 2% to about 20% by weight, and in one embodiment, in an amount from about 5% to about 15% by weight. Suitable fillers that may be used include clay materials such as calcine clay, washed clays, and aluminosilicate clays. Titanium dioxide may also be used as a filler in either anatose or ratile form.

In order to produce a colored laminate paper, the aqueous suspension can contain a dye and optionally pigment particles such as iron oxide particles. The dye present in laminate papers made according to the present invention include leuco sulfur dyes. For many applications, a black dye may be used although sulfur dyes can be red in color, blue in color, and the like. Sulfur dyes are commercially available from numerous sources, such as the Clariant Corporation of Charlotte, N.C. One commercially available black sulfur dye available from the Clariant Corporation is DIERSUL BLACK PD-NA dye.

The amount of sulfur dye present in the laminate paper may vary depending upon the particular application. In general, the sulfur dye may be present in the laminate paper in an amount from about 5 to about 30% by weight, such as from about 15 to about 25% by weight.

Dependent upon the particular application, the leuco sulfur dye added to the laminate paper may need to undergo an oxidation stage followed by an acidification stage. During the reduction/oxidation reaction, the dye is converted from its soluble form into an insoluble form that is deposited into the cellulosic fiber mat. In order to cause oxidation of the dye, an oxidizing agent may be added. The oxidizing agent may be, for instance, metal chlorides or bromates such as zinc chloride or zinc bromate at a rate of between 1:2 and 1:10 on the dye level.

Acidification of the oxidized dye, if desired, can then occur by incorporating a cationic retention aid into the wet end of the papermaking process. In addition to reducing the pH, the cationic retention aid may also provide various other benefits when incorporated into the paper laminate. For instance, in one embodiment, the cationic retention aid may also increase the wet strength of the paper being formed.

Cationic retention aids that may be used in accordance with the present invention include various aluminum compounds, such as polyaluminum silicate sulfate and aluminum sulfate.

In addition to or instead of an aluminum compound, the cationic retention aid may comprise a wet strength resin, such as a cationic amine polymer-epichlorohydrin adduct. For instance, an epichlorohydrin resin as described above is commercially available under the tradename KYMENE marketed by Hercules, Inc. of Wilmington, Del.

The cationic retention aid may be present in the paper laminate in an amount from about 2 lbs. per ton of furnish to about 25 lbs. per ton of furnish. For example, in one embodiment, the cationic retention aid may be added in an amount from about 5 lbs. per ton of furnish to about 10 lbs. per ton of furnish. As stated above, the cationic retention aid may be added at the wet end of the papermaking process. For example, in one particular embodiment, the cationic retention aid may be added to the aqueous suspension of fibers in the whitewater system prior to entering a headbox or after formation by adding to the tray water or the save all system.

In accordance with the present invention, the buffering agent is also added during formation of the laminate paper. The buffering agent is added in an amount sufficient to inhibit acidification of the laminate paper after the paper is formed due to the presence of the sulfur dye. Of particular advantage, the present inventors have discovered that only relatively low amount of the buffering agent are needed to substantially inhibit acidification. For instance, the buffering agent may be added in an amount from about 0.5% to about 5% by weight, such as from about 1% to about 2% by weight.

The buffering agent is generally added to the aqueous suspension of fibers prior to formation of the paper. For instance, the buffering agent may be added to the pulper or may be added via an inline slurry delivery system.

Once formulated, the aqueous suspension of fibers is spread out onto a forming surface and formed into a laminate paper. If desired, a pH-adjusting agent may also be added during formation of the paper.

The pH-adjusting agent may comprise, for instance, sodium carbonate for increasing the pH at the pulper formulation at approximately 2.5 pounds/ton (1-20 pounds/ton).

During the papermaking process, the laminate paper is dried using any conventional equipment. For instance, in one embodiment, the paper is placed on one or more drying drums for drying the paper to a desired dryness.

After the laminate paper is formed, the paper is impregnated with a polymeric resin prior to being laminated to a base material during the production of a laminate. Any suitable polymeric resin may be used in accordance with the present invention. Examples of polymeric resins that may be used to impregnate the laminate paper include, for instance, melamine formaldehyde resins, polyester resins, urea formaldehyde resins, and the like. The polymeric resin may comprise a thermosetting polymer or a thermoplastic polymer. For many applications, the polymeric resin comprises a thermosetting resin that is added to the paper in conjunction with a catalyst system. The catalyst system catalyzes and crosslinks the polymeric resin when subjected to an energy source, such as heat.

The polymeric resin impregnated into the paper substrate can be applied to the paper substrate in various ways. For instance, in one embodiment, the laminate paper can be fed through a size press for applying the polymeric resin. The size press can include, for instance, a flooded nip or a plurality of flooded nips that contact the laminate paper and apply the polymeric resin. Alternatively, the laminate paper can be fed through and soaked in bath containing the polymeric resin. Additionally, the resin can be added via a rotogravure printing process. Preferably, the polymeric resin is added to the paper in an amount sufficient for the resin to penetrate and saturate the paper. By substantially saturating the laminate paper, a uniform composite is formed when the polymeric resin is cured. Thus, the polymeric resin should have a viscosity that will allow it to penetrate the laminate paper in a practical amount of time.

In general, the polymeric resin can be applied to the laminate paper after formation of the laminate paper in an offline process.

During formation of the laminate paper, if desired, the laminate paper may be calendared. Calendaring the laminate paper improves the smoothness of the paper. Increased smoothness may be desired, for instance, if a design or pattern is to be printed onto the laminate paper. In general, the laminate paper may have a BEKK smoothness of from about 10 seconds to about 600 seconds. When calendared, the BEKK smoothness of the laminate paper may be from about 50 seconds to about 600 seconds. When not calendared, on the other hand, the BEKK smoothness of the laminate paper may be from about 10 seconds to about 100 seconds.

The basis weight of laminate papers made in accordance with the present invention can generally range from about 30 gsm to about 120 gsm prior to being impregnated with the polymeric resin. The thickness of the laminate paper can generally be between about 1 mil to about 6 mils.

The laminate paper may have a Gurley porosity from about 5 seconds per 100 cc air to about 50 seconds per 100 cc of air, such as from about 10 seconds per 100 cc air to about 25 seconds per 100 cc of air. Laminate paper as made in accordance with the present invention can also have a wet tensile strength of at least about 700 g/in, such as from about 1000 g/in to about 3500 g/in.

Once a laminate paper is made in accordance with the present invention and impregnated with a polymeric resin, the laminate paper can then be laminated to a base material using any suitable adhesive material. The base material can be, for instance, particleboard, chopped board, or even a polymer based material.

In some applications, the laminate may also include a clear topcoat, covering the paper. The topcoat can be, for instance, a urethane, a silicone wax or a polyvinyl chloride.

Through the process of the present invention, a decorative laminate may be produced that is resistant to delamination and aesthetically appealing.

The present invention may be better understood with reference to the following example.

### EXAMPLE 1

The following example was performed in order to demonstrate some of the benefits and advantages of the present invention.

In this example, three different laminate papers were constructed and tested for pH levels in an oven aging study. The first laminate paper constructed was a control that did not contain a buffering agent in accordance with the present invention. The control sample was formed from the following furnish in a wet papermaking process as described above:

| Ingredient | Tradename | Amount |
|---|---|---|
| Hardwood Eucalyptus Fibers | CENIBRA | 88.7 grams |
| (80% by weight of fiber furnish) | | |
| Northern Softwood Kraft Fibers | DOMTAR Q-90 | 18.0 grams |
| (20% by weight of the fiber | | |
| furnish) | | |
| Black Sulfur Dye | CLARIANT DIERSUL | 37.1 grams |
| | BLACK PD-NA | |
| A Filler | ANSILEX Clay | 17.1 grams |
| Oxidizer | Oxidizer B | 3.9 grams |
| Polyaluminum Silicate Sulfate | | 0.7 grams |
| Alum | | 6.1 grams |
| Alum (2^{nd} addition) | | 6.8 grams |
| Soda Ash | | 1.1 grams |

The above laminate paper was made with a target Gurley porosity of 13 seconds per 100 cc.

A second sample of laminate paper was produced. In accordance with the present invention, the second sample contained 2% by weight Wollastonite (calcium silicate). The Wollastonite was added to replace an equivalent amount of the filler in the above formulation.

A third sample laminate paper was produced that contained as a buffering agent 1.5% by weight magnesium oxide. The magnesium oxide was obtained from Martin Marietta under the name Magnesium Oxide Grade HAS-10. The magnesium oxide had a surface area of approximately 160 m²/g, which is relatively high in comparison to various other commercially available magnesium oxide particles.

A laboratory oven aging study was performed on the three samples. Hot water extracts of the sample papers were obtained over time in order to measure the pH of the paper.

All three samples were placed on a forced air-drying oven in a temperature of 120° C. The samples were placed in the drying oven six days after being produced. The pH of the samples was taken after 30 minutes, 60 minutes, 120 minutes, 240 minutes, 360 minutes, and after 24 hours.

In order to test the pH of the samples, a 1-gram sample of each paper was removed from the oven and combined with 50 cc of boiling water after the 1-gram sample was torn into small pieces. The boiling water and paper were stirred for 5 minutes and left to cool to 50° C. for testing. A pH meter was used to test the pH of the extract.

The following results were obtained:

TABLE 1

| Condition | Control pH | Wollastonite pH | Magnesium Oxide pH |
|---|---|---|---|
| off-machine | 7.6 | 7.36 | 7.73 |
| 6 days old | 7.44 | 7.29 | 7.69 |
| 30 minutes of | 7.1 | 7.13 | 7.56 |
| oven aging* | | | |
| 60 minutes of | 7.04 | 6.8 | 7.56 |
| oven aging* | | | |
| 120 minutes of | 6.74 | 6.46 | 7.26 |
| oven aging* | | | |
| 240 minutes of | 6.64 | 6.4 | 7.18 |
| oven aging* | | | |
| 360 minutes of | 6.45 | 6.24 | 7.12 |
| oven aging* | | | |
| 24 hours of | 5.73 | 5.62 | 6.97 |
| oven aging* | | | |

*Oven aging was performed on the samples after they had naturally aged for six days.

As shown above, the magnesium oxide buffering agent was very effective in controlling the pH of the laminate paper.

In comparison, the laminate paper containing Wollastonite was not as successful in controlling pH. It is believed, however, that the sample containing the Wollastonite may have contained greater amounts of the oxidizer than necessary. For instance, the initial pH of the Wollastonite sample indicates that problems may have occurred during formation of the laminate paper.

### EXAMPLE 2

Example 1 was repeated on various laboratory handsheets.

During this example, the following handsheets were produced:

Control:

| Ingredient | Tradename | Amount |
|---|---|---|
| Hardwood Eucalyptus Fibers | CENIBRA | 88.7 grams |
| (80% by weight of fiber furnish) | | |
| Northern Softwood Kraft Fibers | DOMTAR Q-90 | 18.0 grams |
| (20% by weight of the fiber | | |
| furnish) | | |
| Black Sulfur Dye | CLARIANT DIERSUL | 37.1 grams |
| | BLACK PD-NA | |
| A Filler | ANSILEX Clay | 13.5 grams |
| Oxidizer | Oxidizer B | 3.9 grams |
| Polyaluminum Silicate Sulfate | | 0.7 grams |
| Alum | | 6.1 grams |
| Alum (2^{nd} addition) | | 6.8 grams |
| Soda Ash | | 1.1 grams |

Sample 1: contained 2% by weight diatomaceous earth as a buffering agent.

Sample 3: contained 2% by weight aluminum oxide.

Sample 4: contained 2% by weight magnesium oxide.

Sample 5: contained 2% by weight magnesium carbonate hydroxide.

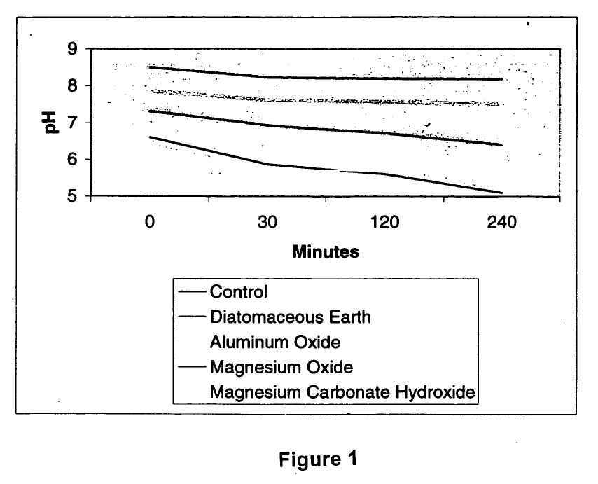

Each of the handsheets was subjected to an oven aging study as described in Example 1. The results are illustrated in FIG. 1.

As shown in FIG. 1, magnesium oxide, magnesium carbonate hydroxide, and diatomaceous earth were very effective in controlling and stabilizing the pH of the laminate paper.

These and other modifications and variations to the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention.

1. A laminate paper comprising:
a paper substrate comprising cellulosic fibers and a filler, the paper substrate further comprising a sulfur dye and a buffering agent, the buffering agent inhibiting acidification of the paper substrate due to the presence of the sulfur dye, the buffering agent comprising an inorganic or organic mineral, the buffering agent being present in the paper substrate in an amount of from about 0.5% to less than 5% by weight of the paper substrate on a dry basis.

2. A laminate paper as defined in claim 1, wherein the buffering agent comprises a magnesium oxide, magnesium carbonate hydroxide, calcium silicate, calcium carbonate, aluminum oxide, aluminum hydroxide, an organic diatome, a barium salt, a beryllium salt, or mixtures thereof.

3. A laminate paper as defined in claim 1, further comprising a cationic retention aid.

4. A laminate paper as defined in claim 3, wherein the cationic retention aid comprises poly-aluminum silicate sulfate, aluminum sulfate, or mixtures thereof, the cationic retention aid being present in the paper substrate in an amount from about 2 lbs. per ton of furnish to about 15 lbs. per ton of furnish used to form the paper substrate.

5. A laminate paper as defined in claim 1, wherein the buffering agent is present in the paper substrate in an amount from about 1% to about 2% by weight.

6. A laminate paper as defined in claim 1, wherein the buffering agent comprises a magnesium salt.

7. A laminate paper as defined in claim 1, wherein the paper substrate has a basis weight of from about 30 gsm to about 120 gsm, has a tensile strength of from about 700 g/in to about 3500 g/in, and has a BEKK smoothness of from about 10 seconds to about 600 seconds.

8. A laminate paper as defined in claim 1, wherein the paper substrate has a Gurley porosity of from about 8 to about 50 seconds per 100 cc of air.

9. A laminate paper as defined in claim 1, wherein the filler comprises a clay, titanium dioxide, or mixtures thereof, the filler being present in the substrate in an amount from about 4% to about 40% by weight.

10. A laminate paper as defined in claim 1, wherein a hot water extract of the paper substrate after being formed has an initial pH of greater than 6.8.

11. A laminate paper as defined in claim 1, wherein after 2 hours of being formed, a hot water extract of the paper substrate has a pH of greater than about 6.8.

12. A laminate paper as defined in claim 1, wherein after 24 hours of being formed, a hot water extract of the paper substrate has a pH of greater than about 6.8.

13. A laminate paper as defined in claim 1, wherein the sulfur dye comprises a black sulfur dye.

14. A laminate paper as defined in claim 1, wherein the paper substrate has been impregnated with a polymeric resin.

15. A laminate paper as defined in claim 14, wherein the polymeric resin comprises a thermoset polymer.

16. A laminate paper as defined in claim 14, wherein the polymeric resin comprises a melamine formaldehyde resin, a polyester resin, a urea formaldehyde resin or combinations thereof.

17. A process for forming a laminate paper comprising:
forming a paper substrate from an aqueous suspension of fibers and a filler, the paper substrate further containing a sulfur dye; and
incorporating into the paper substrate a buffering agent, the buffering agent being present in an amount sufficient to inhibit acidification of the paper substrate due to the presence of the sulfur dye, the buffering agent comprising an inorganic or organic mineral, the buffering agent being present in the paper substrate in an amount from about 0.5% to less than 5% by weight.

18. A process as defined in claim 17, wherein the buffering agent comprises a magnesium oxide, magnesium carbonate hydroxide, calcium silicate, calcium carbonate, aluminum oxide, aluminum hydroxide, an organic diatome, a barium salt, a beryllium salt, or mixtures thereof.

19. A process as defined in claim 17, further comprising the step of incorporating a cationic retention aid into the paper substrate.

20. A process as defined in claim 19, wherein the cationic retention aid comprises poly-aluminum silicate sulfate, aluminum sulfate, or mixtures thereof, the cationic retention aid being present in the paper substrate in an amount from about 2 lbs. per ton of furnish to about 15 lbs. per ton of furnish used to form the paper substrate.

21. A process as defined in claim 17, wherein the paper substrate has a basis weight of from about 30 gsm to about 120 gsm, has a tensile strength of from about 700 g/in to about 3500 g/in, has a BEKK smoothness of from about 10 seconds to about 600 seconds, and has a Gurley porosity of from about 8 to about 50 seconds.

22. A process as defined in claim 17, wherein the polymeric resin comprises a melamine formaldehyde resin, a polyester resin, a urea formaldehyde resin or combinations thereof.

23. A process as defined in claim 17, wherein after 2 hours of being formed, a hot water extract of the paper substrate has a pH of greater than about 6.8.

24. A process as defined in claim 17, wherein after 24 hours of being formed, a hot water extract of the paper substrate has a pH of greater than about 6.8.

25. A process as defined in claim 17, further comprising the step of impregnating the paper substrate with a polymeric resin.

26. A laminate comprising:
a base material; and
an overlay layer positioned over the base material, the overlay layer comprising a paper substrate containing cellulosic fibers and a filler, the paper substrate further comprising a sulfur dye and a buffering agent, the buffering agent inhibiting acidification of the paper substrate due to the presence of the sulfur dye, the buffering agent comprising an inorganic mineral, the buffering agent being present in the paper substrate in an amount from about 0.5% to less than 5% by weight, the buffering agent being present in the paper substrate such that a hot water extract of the paper substrate after the substrate is formed has a pH of greater than about 6.8, the paper substrate being impregnated with a polymeric resin.

27. A laminate as defined in claim 26, further comprising a clear topcoat positioned over the overlay layer.

28. A laminate as defined in claim 26, wherein the buffering agent comprises a magnesium oxide, magnesium carbonate hydroxide, calcium silicate, calcium carbonate, aluminum oxide, aluminum hydroxide, diatomaceous earth, a barium salt, a beryllium salt, or mixtures thereof.

29. A laminate as defined in claim 26, further comprising a cationic retention aid.

30. A laminate as defined in claim 26, wherein after 24 hours of being formed, a hot water extract of the paper substrate has a pH of greater than about 6.8.
